(19) United States
(12) Patent Application Publication
(10) Pub. No.: US 2017/0123623 A1
(43) Pub. Date: May 4, 2017

(54) TERMINATING COMPUTING APPLICATIONS USING A GESTURE

(71) Applicant: Google Inc., Mountain View, CA (US)

(72) Inventors: Zhou Bailiang, Seattle, WA (US); Kevin Allekotte, Tokyo (JP)

(21) Appl. No.: 14/927,318

(22) Filed: Oct. 29, 2015

(51) Int. Cl. G06F 3/0488

(52) U.S. Cl. CPC G06F 3/0488

(57) ABSTRACT

In general, this disclosure is directed to techniques for outputting, by a computing device and for display, a graphical user interface of an application currently executing at the computing device (582). A presence-sensitive input device detects two gestures (584, 588). The computing device determines whether the first gesture starts within a first target starting area of the presence-sensitive input device and terminates in a first target termination area (586), and whether the second gesture starts in a second target starting area of the presence-sensitive input device and terminates in a second target termination area (590). If the conditions are satisfied, the computing device determines whether an amount of time between termination of the first gesture and initiation of the second gesture satisfies a timeout threshold (592), ceasing the output of the graphical user interface when the timeout threshold is satisfied (594).

### BACKGROUND

Most computing devices (e.g., mobile phones, tablet computers, computerized wearable devices, etc.) provide user interfaces to control various applications currently executing at the computing device. The user interfaces enable a user to provide input and perceive various outputs of the executing application. Each application, however, may provide a different process for terminating execution of the application (i.e., quitting the application), each type or form factor of computing device may require a different process for terminating applications, and the process for terminating applications may require multiple user inputs. As such, many user interfaces include graphical or textual indications of how to terminate an application that are displayed while the application is executing, which reduces the amount of screen space available for other application features.

### SUMMARY

In one example, a method may include outputting, by a computing device and for display, a graphical user interface of an application currently executing at the computing device, detecting, by a presence-sensitive input device operably coupled to the computing device, a first gesture, determining, by the computing device, whether the first gesture is initiated within a first target starting area of the presence-sensitive input device and terminates in a first target termination area of the application window diagonal from the first target starting area, detecting, by the presence-sensitive input device, a second gesture, determining, by the computing device, whether the second gesture is initiated in a second target starting area of the presence-sensitive input device and terminates in a second target termination area of the presence-sensitive input device diagonal from the second target starting area, wherein the second target starting area is different from the first target starting and first target termination areas, determining, by the computing device, whether an amount of time between termination of the first gesture and initiation of the second gesture satisfies a timeout threshold, and responsive to determining that the amount of time satisfies the timeout threshold, that the first gesture is initiated within the first target starting area and terminates in the first target termination area and that the second gesture is initiated within the second target starting area and terminates in the second target termination area, ceasing the output of the graphical user interface of the application at the computing device.

In another example, a computing device may include a display device, a presence-sensitive input device, and at least one processor configured to output, for display on the display device, a graphical user interface of an application currently executing at the computing device, detect, using the presence-sensitive input device, a first gesture, determine whether the first gesture is initiated within a first target starting area of the presence-sensitive input device and terminates in a first target termination area of the presence-sensitive input device diagonal from the first target starting area, detect, using the presence-sensitive input device, a second gesture, determine whether the second gesture is initiated in a second target starting area of the presence-sensitive input device and terminates in a second target termination area of the presence-sensitive input device diagonal from the second target starting area, wherein the second target starting area is different from the first target starting and first target termination areas, determine whether an amount of time between termination of the first gesture and initiation of the second gesture satisfies a timeout threshold, and responsive to determining that the amount of time satisfies the timeout threshold, that the first gesture is initiated within the first target starting area and terminates in the first target termination area and that the second gesture is initiated within the second target starting area and terminates in the second target termination area, cease the output of the graphical user interface of the application at the computing device.

In another example, a computer-readable storage medium includes instructions that, when executed, cause at least one processor of a computing device to output, for display on the display device, a graphical user interface of an application currently executing at the computing device, detect, using a presence-sensitive input device, a first gesture, determine whether the first gesture is initiated within a first target starting area of the presence-sensitive input device and terminates in a first target termination area of the presence-sensitive input device diagonal from the first target starting area, detect, using the presence-sensitive input device, a second gesture, determine whether the second gesture is initiated in a second target starting area of the presence-sensitive input device and terminates in a second target termination area of the presence-sensitive input device diagonal from the second target starting area, wherein the second target starting area is different from the first target starting and first target termination areas, determine whether an amount of time between termination of the first gesture and initiation of the second gesture satisfies a timeout threshold, and responsive to determining that the amount of time satisfies the timeout threshold, that the first gesture is initiated within the first target starting area and terminates in the first target termination area and that the second gesture is initiated within the second target starting area and terminates in the second target termination area, cease the output of the graphical user interface of the application at the computing device.

The details of one or more examples are set forth in the accompanying drawings and the description below. Other features, objects, and advantages will be apparent from the description and drawings, and from the claims.

### BRIEF DESCRIPTION OF DRAWINGS

FIG. 1 is a conceptual diagram illustrating an example system including a computing device that terminates an application in response to detecting an application termination gesture, in accordance with one or more aspects of the present disclosure.

FIG. 2 is a block diagram illustrating an example computing device, in accordance with one or more aspects of the present disclosure.

FIG. 3 is a block diagram illustrating an example computing device that outputs screen content for display at a remote device, in accordance with one or more techniques of the present disclosure.

FIG. 4 is a conceptual diagram illustrating an example system including a computing device that receives a pair of gestures that do not completely satisfy the requirements for terminating an application executing on the computing device, in accordance with one or more aspects of the present disclosure.

FIG. 5 is a flow chart illustrating example operations of a computing device that implements techniques for terminating an application executing on the computing device, in accordance with one or more aspects of the present disclosure.

### DETAILED DESCRIPTION

In general, techniques of this disclosure may enable a computing device to terminate execution of an application in response to detecting a single compound gesture that may be universal across different form factors, different device types, and different applications. The compound gesture may include a sequence of two simple gestures detected by a presence-sensitive input device of the computing device. Such a compound gesture may not require a visual indication of how to terminate the currently executing application (e.g., a “close” button or other textual or graphical element), thereby freeing up screen space for other application features.

In operation, a computing device may institute certain constraints on gestures that terminate an application so as to reduce the likelihood that such that the received gestures are mischaracterized, which may minimize the chance of a user accidentally terminating the application. For instance, the computing device may institute a constraint that each of the received gestures begin in a particular area of the presence-sensitive input device and end in a particular area of the presence-sensitive input device. The computing device may also institute a time constraint between the time at which the first gesture is terminated and the time at which the second gesture is initiated. By adding these constraints to the detection of the two gestures that form the compound gesture, a computing device may provide the functionality of quickly and simply terminating the execution of an application while also discerning a likely intent of the user by performing the compound gesture. The compound gesture may increase the efficiency of terminating applications executing on the computing device, which may save processing and battery power.

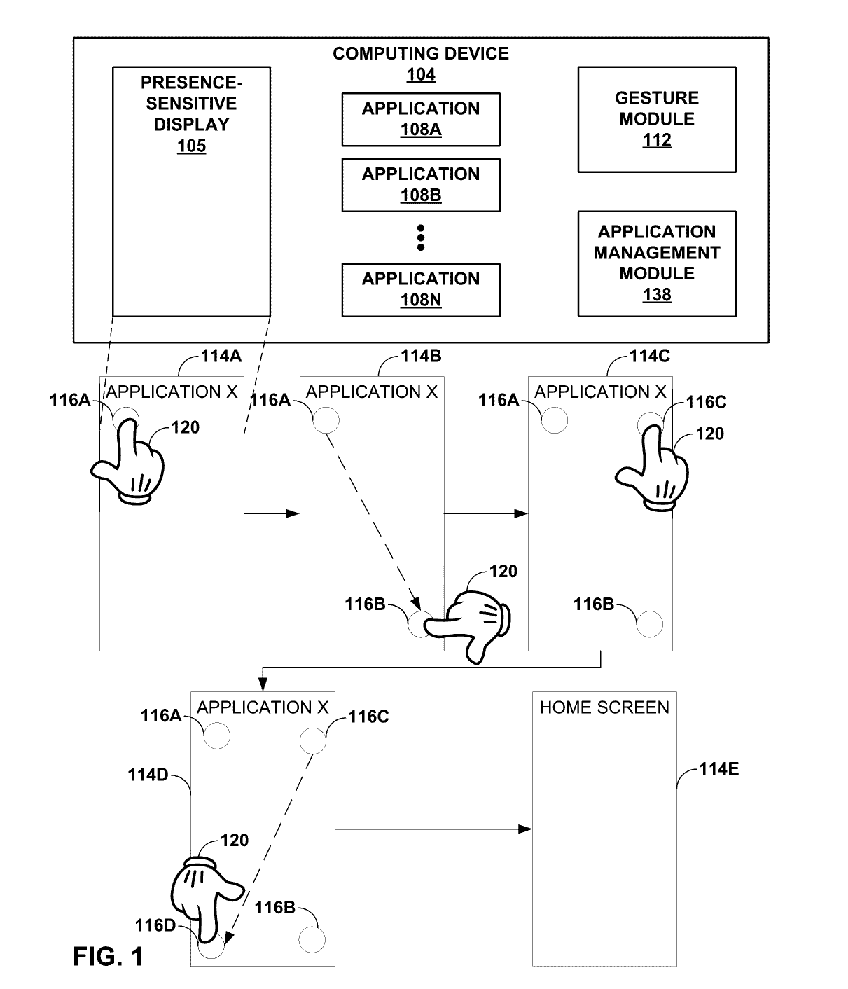

FIG. 1 is a conceptual diagram illustrating an example system including a computing device that terminates an application in response to detecting an application termination gesture, in accordance with one or more aspects of the present disclosure. Computing device 104 is described below as a smart phone. However, in some examples, computing device 104 may be a computerized watch (e.g., a smart watch), computerized eyewear, computerized headwear, other types of wearable computing devices, a tablet computer, a personal digital assistant (PDA), a laptop computer, a gaming system, a media player, an e-book reader, a television platform, an automobile navigation system, a digital camera, or any other type of mobile and/or non-mobile computing device that is configured to detect a compound gesture and/or receive an indication of the compound gesture and, in response, terminate a currently executing application.

Computing device 104 includes presence-sensitive display 105, applications 108A-N (collectively, “applications 108”), and gesture module 112. Applications 108 and gesture module 112 may perform operations described herein using software, hardware, firmware, or a mixture of hardware, software, and/or firmware residing in and/or executing at computing device 104. Computing device 104 may execute applications 108 and gesture module 112 with one or more processors. In some examples, computing device 104 may execute applications 108 and gesture module 112 as one or more virtual machines executing on underlying hardware of computing device 104. Applications 108 and gesture module 112 may execute as one or more services or components of operating systems or computing platforms of computing device 104. Applications 108 and gesture module 112 may execute as one or more executable programs at application layers of computing platforms of computing device 104 with operating system privileges or with access to a runtime library of computing device 104. In some examples, presence-sensitive display 105, applications 108, and/or gesture module 112 may be arranged remotely to and be remotely accessible to computing device 104, for instance, via interaction by computing device 104 with one or more remote network devices.

Presence-sensitive display 105 of computing device 104 may include respective input and/or output components for computing device 104. In some examples, presence-sensitive display 105 may function as input component using a presence-sensitive input component. Presence-sensitive display 105, in such examples, may be a resistive touchscreen, a surface acoustic wave touchscreen, a capacitive touchscreen, a projective capacitance touchscreen, a pressure sensitive screen, an acoustic pulse recognition touchscreen, or another display component technology. Presence-sensitive display 105 may also output content in a graphical user interface in accordance with one or more techniques of the current disclosure, such as a liquid crystal display (LCD), a dot matrix display, a light emitting diode (LED) display, an organic light-emitting diode (OLED) display, e-ink, or similar monochrome or color displays capable of outputting visible information to a user of computing device 104.

In some examples, presence-sensitive display 105 receives tactile input from a user of computing device 104, such as using tactile device 120. In some examples, presence-sensitive display 105 may receive indications of tactile input by detecting one or more gestures from a user in control of tactile device 120. Such gestures are sometimes called “swipes” or “drags”. Although only one contact point is described, teachings here may be expanded to incorporate a multi-contact-point gesture, such as “pinch in” or “pinch out” gesture, a two-finger linear or rotational swipe, or other variants. In some such examples, tactile device 120 may be a finger or a stylus pen that the user utilizes to touch or point to one or more locations of presence-sensitive display 105. In various instances, a sensor of presence-sensitive display 105 may detect a user's movement (e.g., moving a hand, an arm, a pen, a stylus, etc.) within a threshold distance of the sensor of presence-sensitive display 105. In some instances of providing the compound gesture described herein, multi-finger gestures may be used, alone or in combination with single-finger gestures. For instance, both the first gesture and the second gesture may be multi-finger gestures. In other instances, the first gesture may be a multi-finger gesture and the second gesture may be a single-finger gesture. In still other instances, the first gesture may be a single-finger gesture and the second gesture may be a multi-finger gesture. In still other instances, both the first gesture and the second gesture may be single-finger gestures.

Presence-sensitive display 105 may further present output to a user. Presence-sensitive display 105 may present the output as a graphical user interface, which may be associated with functionality provided by computing device 104. For example, presence-sensitive display 105 may present various user interfaces related to the functionality of computing platforms, operating systems, applications, and/or services executing at or accessible by computing device 104 (e.g., notification services, electronic message applications, Internet browser applications, mobile or desktop operating systems, etc.). A user may interact with a user interface presented at presence-sensitive display 105 to cause computing device 104 to perform operations relating to functions.

Presence-sensitive display 105 may output a graphical user interface of one of applications 108, such as application 108A, which is currently executing on computing device 104. In the example of FIG. 1, the graphical user interface encompasses the entire display, though in other instances, the graphical user interface may be contained within an application window that may be smaller than the full display. Application 108A may be any application that can execute on computing device 104, such as a browser application, a gaming application, a banking application, or any other application suited for execution on computing device 104.

As shown in FIG. 1, computing device 104 may include one or more applications 108 which may be organized or otherwise structured into an application list. The application list may be a list, queue, collection, etc. of applications 108. In some examples, the application list may impose an order on the applications in which they can be iterated through for display. To determine which applications are presently active and/or stored in memory, application management module 138 may execute in user space and access a component of an operating system on computing device 104, such as a process table or scheduler. In other examples, application management module 138 may be included as a component within the operating system. In still other examples, application management module 138 may query a separate manager module that manages the application list in order to determine a foreground application from the application list. A currently executing application 108A may be used to control at least part of the graphical user interface shown by the presence-sensitive display 105.

Presence-sensitive display 105 may detect a first gesture. For example, as shown in interface 114A, presence-sensitive display 105 may detect an initiation of a first gesture from tactile device 120 at gesture point 116A. The first gesture, as shown in interface 114B, may include moving tactile device 120 along presence-sensitive display 105 from gesture point 116A to 116B. In other examples, the first gesture may originate at a point on presence-sensitive display 105 different than gesture point 116A and/or terminate at a point on presence-sensitive display 105 different than gesture point 116B.

Gesture module 112 may determine whether the first gesture was initiated within a first target starting area of presence-sensitive display 105 and was terminated in a first target termination area of presence-sensitive display 105. For example, gesture module 112 may receive an indication of the first gesture that traveled from gesture point 116A to gesture point 116B. Gesture module 112 may determine whether gesture point 116A is in a first target starting area of presence-sensitive display 105. If gesture point 116A is in the first target starting area, gesture module 112 may then determine whether the termination point of gesture point 116B is in a first target termination area diagonal of gesture point 116A. Based on these determinations, gesture module 112 may determine that the first gesture is a generally diagonal gesture that traveled across presence-sensitive display 105 and that the first gesture may match a first portion of a compound gesture.

Presence-sensitive display 105 may detect a second gesture. For example, as shown in interface 114C, presence-sensitive display 105 may detect an initiation of a second gesture from tactile device 120 at gesture point 116C. The second gesture, as shown in interface 114D, may include moving tactile device 120 along presence-sensitive display 105 from gesture point 116C to gesture point 116D. In other examples, the second gesture may originate in a point on presence-sensitive display 105 different than gesture point 116C and/or terminate at a point on presence-sensitive display 105 different than gesture point 116D.

Gesture module 112 may determine whether the second gesture was initiated within a second target starting area of presence-sensitive display 105 and was terminated in a second target termination area of presence-sensitive display 105. For the second gesture, the second target starting area is different than the first target starting and first target termination area. For example, gesture module 112 may receive an indication of the second gesture that traveled from gesture point 116C to gesture point 116D. Gesture module 112 may determine whether gesture point 116C is in the second target starting area of presence-sensitive display 105. If gesture point 116C is in the second target starting area, gesture module 112 may then determine whether the termination point of gesture point 116D is in the second target termination area diagonal of gesture point 116C.

Gesture module 112 may further determine whether an amount of time between termination of the first gesture and initiation of the second gesture satisfies a timeout threshold. The timeout threshold, in some examples, may be 0.2 seconds, 0.5 seconds, 1 second, etc. In other examples, however, the timeout threshold may be less than 0.2 seconds or greater than 1 second.

The first gesture (from the first target starting area to the first target termination area) and the second gesture (from the second target starting area different from the first target starting and first target termination areas to the second target termination area) may form a shape similar to that of an ‘X’. However, many applications may include functionality for a gesture from a corner of presence-sensitive display 105 to a diagonal corner of presence-sensitive display 105. By including the timeout threshold, gesture module 112 may more accurately discern an intent of a user operating tactile device 120. For instance, if the amount of time between the termination of the first gesture and the initiation of the second gesture satisfies the timeout threshold, gesture module 112 may determine that the user intended to terminate the execution of application 108A. Conversely, if the amount of time between the two gestures does not satisfy the timeout threshold, such as if the amount of time is greater than the timeout threshold, gesture module 112 may determine that the gestures were not input with the intention of terminating the execution of application 108A.

Responsive to determining that the amount of time satisfies the timeout threshold, application management module 138 may cease the output of the graphical user interface of application 108A at computing device 104. For example, if gesture module 112 determines that the above constraints are satisfied, application management module 138 may cause computing device 104 to cease the execution of application 108A and output a graphical user interface of a second application in the list of applications determined above, such as application 108B or output a graphical user interface of a home screen.

By implementing techniques of this disclosure, a computing device, such as computing device 104, may provide an efficient and intuitive method of terminating the execution of an application on the computing device. Including an additional element within a graphical user interface leads to a more crowded graphical user interface, as the additional element must be incorporated somehow. Rather than requiring an additional element within a graphical user interface or requiring a change in the graphical user interface in order to terminate an application, enabling application termination via an X-shaped compound gesture performed within a timeout threshold provides the user with the capability to quickly terminate the execution of an application executing on the computing device. Further, the compound gesture for terminating the application may reduce the amount of time the computing device must execute the application compared to the example where the graphical user interface must change, which may further reduce the processing power required of the computing device and saving battery power of the computing device. Techniques of this disclosure may further enable the graphical user interface to remain unchanged and uncluttered by the addition of an element that can be used to terminate the application.

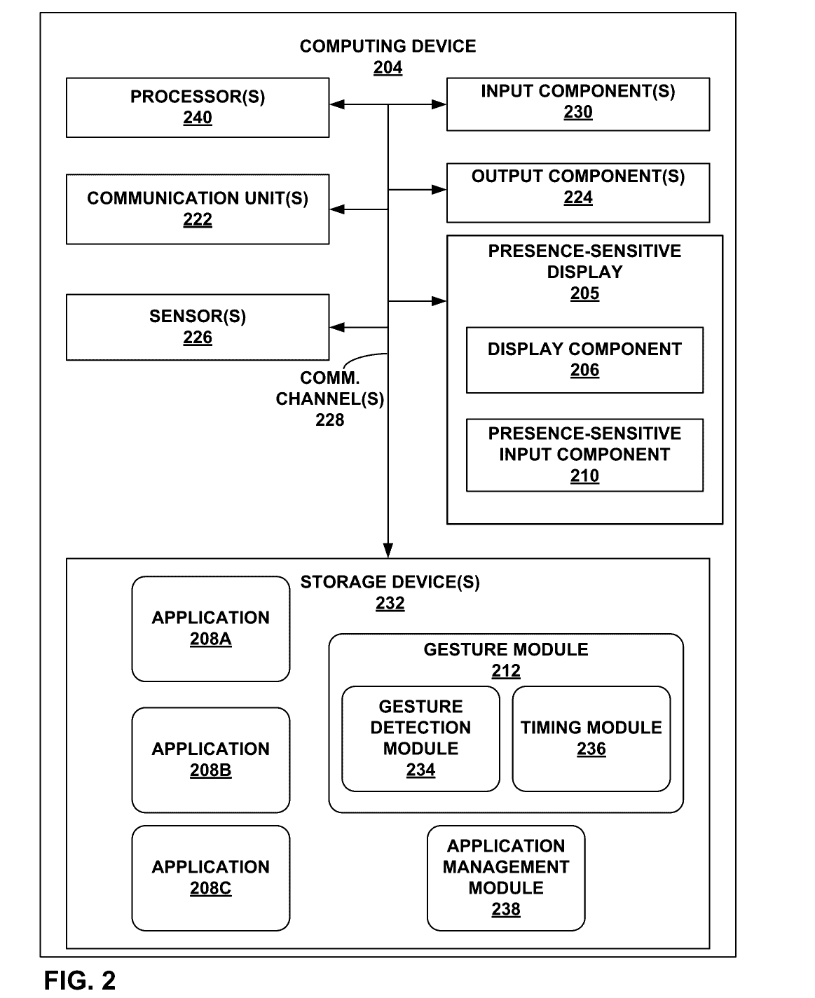

FIG. 2 is a block diagram illustrating an example computing device 204 configured to receive a compound gesture and, responsively, terminate an application executing on computing device 204, in accordance with one or more aspects of the present disclosure. Computing device 204 of FIG. 2 is described below within the context of computing device 104 of FIG. 1. Computing device 204 of FIG. 2 in some examples represents an example of computing device 104 of FIG. 1. FIG. 2 illustrates only one particular example of computing device 204, and many other examples of computing device 204 may be used in other instances and may include a subset of the components included in example computing device 204 or may include additional components not shown in FIG. 2.

As shown in the example of FIG. 2, computing device 204 includes presence-sensitive display 205, one or more processors 240, one or more input components 230, one or more communication units 222, one or more output components 224, and one or more storage components 232. Presence-sensitive display (PSD) 205 includes display component 206 and presence-sensitive input component 210.

One or more storage components 232 of computing device 204 are configured to store applications 208A-208C, gesture module 212, and application management module 238. Additionally, gesture module 212 may include more specialized modules, such as gesture detection module 234 and timing module 236.

Communication channels 228 may interconnect each of the components 240, 222, 224, 226, 230, 205, 206, 210, 232, 208A-208C, 212, 234, 236, and 238 for inter-component communications (physically, communicatively, and/or operatively). In some examples, communication channels 228 may include a system bus, a network connection, an inter-process communication data structure, or any other method for communicating data.

Computing device 204, in one example, also includes one or more input components 230. Input component 230, in some examples, is configured to receive input from a user through tactile, audio, or video feedback. Examples of input component 230 include a display component, a mouse, a keyboard, a camera, a microphone or any other type of device for detecting input from a user. In some examples, a display component includes a touch-sensitive screen.

One or more output components 224 may also be included in computing device 204. Output component 224, in some examples, is configured to provide output to a user using tactile, audio, or video stimuli. Output component 224, in one example, includes an electronic display, a loudspeaker, or any other type of device for converting a signal into an appropriate form understandable to humans or machines. The electronic display may be an LCD or OLED part of a touch screen, may be a non-touchscreen direct view display component such as a CRT, LED, LCD, or OLED. The display component may also be a projector instead of a direct view display.

One or more communication units 222 of computing device 204 may communicate with external devices via one or more wired and/or wireless networks by transmitting and/or receiving network signals on the one or more networks. Communication unit 222 may be a network interface card, such as an Ethernet card, an optical transceiver, a radio frequency transceiver, or any other type of device that can send and receive information. Examples of such network interfaces may include Bluetooth, infrared signaling, 3G, LTE, and Wi-Fi radios as well as Universal Serial Bus (USB) and Ethernet. In some examples, computing device 204 utilizes communication unit 222 to wirelessly communicate with another computing device that is operably coupled to computing device 204.

Presence-sensitive display (PSD) 205 of computing device 204 includes display component 206 and presence-sensitive input component 210. Display component 206 may be a screen at which information is displayed by PSD 205 and presence-sensitive input component 210 may detect an object at and/or near display component 206. As one example range, presence-sensitive input component 210 may detect an object, such as a finger, stylus, or tactile device 120 that is within two inches or less of display component 206. Presence-sensitive input component 210 may determine a location (e.g., an [x, y] coordinate) of display component 206 at which the object was detected. In another example range, presence-sensitive input component 210 may detect an object six inches or less from display component 206 and other ranges are also possible. Presence-sensitive input component 210 may determine the location of display component 206 selected by a user's finger using capacitive, inductive, and/or optical recognition techniques. In some examples, presence-sensitive input component 210 also provides output to a user using tactile, audio, or video stimuli as described with respect to display component 206. In the example of FIG. 2, PSD 205 may present a user interface (such as a graphical user interface for presenting a graphical image having an emotional classification that is associated with an emotion tag of a captured image).

While illustrated as an internal component of computing device 204, presence-sensitive display 205 may also represent and external component that shares a data path with computing device 204 for transmitting and/or receiving input and output. For instance, in one example, PSD 205 represents a built-in component of computing device 204 located within and physically connected to the external packaging of computing device 204 (e.g., a screen on a mobile phone). In another example, PSD 205 represents an external component of computing device 204 located outside and physically separated from the packaging of computing device 204 (e.g., a monitor, a projector, etc. that shares a wired and/or wireless data path with computing device 204).

PSD 205 of computing device 204 may receive tactile input from a user of computing device 204. PSD 205 may receive indications of the tactile input by detecting one or more gestures from a user of computing device 204 (e.g., the user touching or pointing to one or more locations of PSD 205 with a finger or a stylus pen). PSD 205 may present output to a user. PSD 205 may present the output as a graphical user interface (e.g., as graphical screen shot 116), which may be associated with functionality provided by computing device 204. For example, PSD 205 may present various user interfaces of components of a computing platform, operating system, applications, or services executing at or accessible by computing device 204 (e.g., an electronic message application, a navigation application, an Internet browser application, a mobile operating system, etc.). A user may interact with a respective user interface to cause computing devices 210 to perform operations relating to a function. The user of computing device 204 may view output and provide input to PSD 205 to compose and read messages associated with the electronic messaging function.

PSD 205 of computing device 204 may detect two-dimensional and/or three-dimensional gestures as input from a user of computing device 204. For instance, a sensor of PSD 205 may detect a user's movement (e.g., moving a hand, an arm, a pen, a stylus, etc.) within a threshold distance of the sensor of PSD 205. PSD 205 may determine a two or three dimensional vector representation of the movement and correlate the vector representation to a gesture input (e.g., a hand-wave, a pinch, a clap, a pen stroke, etc.) that has multiple dimensions. In other words, PSD 205 can detect a multi-dimension gesture without requiring the user to gesture at or near a screen or surface at which PSD 205 outputs information for display. Instead, PSD 205 can detect a multi-dimensional gesture performed at or near a sensor which may or may not be located near the screen or surface at which PSD 205 outputs information for display.

One or more processors 240, in one example, are configured to implement functionality and/or process instructions for execution within computing device 204. For example, processors 240 may be capable of processing instructions stored in storage device 232. Examples of processors 240 may include, any one or more of a microprocessor, a controller, a digital signal processor (DSP), an application specific integrated circuit (ASIC), a field-programmable gate array (FPGA), or equivalent discrete or integrated logic circuitry.

In some examples, computing device 204 may include one or more sensors 226. One or more of sensors 226 may measure one more measurands. Examples of one or more of sensors 226 may include one or more position sensors (e.g., a global positioning system (GPS) sensor, an indoor positioning sensor, or the like), one or more motion/orientation sensors (e.g., an accelerometer, a gyroscope, or the like), a light sensor, a temperature sensor, a pressure (or grip) sensor, a physical switch, a proximity sensor, and one or more bio-sensors that can measure properties of the skin/blood, such as alcohol, blood sugar, heart rate, perspiration level, etc.

One or more storage components 232 within computing device 204 may store information for processing during operation of computing device 204 (e.g., computing device 204 may store data accessed by modules 212, 234, 236, and 238 during execution at computing device 204). In some examples, storage component 232 is a temporary memory, meaning that a primary purpose of storage component 232 is not long-term storage. Storage components 232 on computing device 204 may be configured for short-term storage of information as volatile memory and therefore not retain stored contents if powered off. Examples of volatile memories include random access memories (RAM), dynamic random access memories (DRAM), static random access memories (SRAM), and other forms of volatile memories known in the art.

Storage components 232, in some examples, also include one or more computer-readable storage media. Storage components 232 may be configured to store larger amounts of information than volatile memory. Storage components 232 may further be configured for long-term storage of information as non-volatile memory space and retain information after power on/off cycles. Examples of non-volatile memories include magnetic hard discs, optical discs, floppy discs, flash memories, or forms of electrically programmable memories (EPROM) or electrically erasable and programmable (EEPROM) memories. Storage components 232 may store program instructions and/or information (e.g., data) associated with modules 212, 234, 236, and 238, as well as data stores 280.

In accordance with techniques of the current disclosure, application management module 238 may output, via display component 206, a graphical user interface of one of applications 208A-208C, such as application 208A, which is currently executing on computing device 204. In some examples, the graphical user interface encompasses the entire display component 206, though in other instances, the graphical user interface may be contained within an application window that may be smaller than the full display component 206. Application 208A may be any application that can execute on computing device 204, such as a browser application, a gaming application, a banking application, or any other application suited for execution on computing device 204.

Gesture detection module 234 may detect a first gesture input using presence-sensitive input component 210. For example, gesture detection module 234 may detect an initiation of a first gesture from a tactile device (e.g., tactile device 120) at an upper-left corner of presence-sensitive input component 210. The first gesture may include moving tactile device 120 along presence-sensitive input component 210 from the upper-left corner of presence-sensitive input component 210 diagonally to a lower-right corner of presence-sensitive input component 210. In other examples, the first gesture may originate at a point on presence-sensitive input component 210 different than the upper-left corner and/or terminate at a point on presence-sensitive input component 210 different than the lower-right corner. In some examples, responsive to detecting the first gesture, gesture detection module 234 may output, for display at display component 206, a first trail substantially traversing the first gesture. In other words, gesture detection module 234 may output, for display at display component 206, a graphical element that marks the path taken by tactile device 120 during the first gesture. The graphical element may be of any suitable style, including a solid path, a dotted or dashed path, or some other patterned path, any of which may have varying line weights.

Gesture detection module 234 may determine whether the first gesture was initiated within a first target starting area of presence-sensitive input component 210 and was terminated in a first target termination area of presence-sensitive input component 210. The first target starting area may be an area on presence-sensitive input component 210 that corresponds to an upper-left corner of the graphical user interface. Further, the first target termination area may be an area on presence-sensitive input component 210 that corresponds to a lower-right corner of the graphical user interface. For example, gesture detection module 234 may receive an indication of the first gesture that traveled from the upper-left corner of presence-sensitive input component 210 to the lower-right corner of presence-sensitive input component 210, as described above. Gesture detection module 234 may determine whether the first gesture begins in a first target starting area of presence-sensitive input component 210 (e.g., the upper-left corner). If the first gesture begins in the first target starting area, gesture detection module 234 may then determine whether the termination point of the first gesture is in a first target termination area of presence-sensitive input component 210 (e.g., the lower-right corner) diagonal of the beginning point of the first gesture.

Gesture detection module 234 may detect a second gesture using presence-sensitive input component 210. For example, gesture detection module 234 may detect an initiation of a second gesture from tactile device 120 at an upper-right corner of presence-sensitive input component 210. The second gesture may include moving tactile device 120 along presence-sensitive input component 210 from the upper-right corner of presence-sensitive input component 210 diagonally to a lower-left corner of presence-sensitive input component 210. In other examples, the second gesture may originate in a point on presence-sensitive input component 210 different than the upper-right corner and/or terminate at a point on presence-sensitive input component 210 different than the lower-left corner. In some examples, responsive to detecting the second gesture, gesture detection module 234 may output, for display at display component 206, a second trail substantially traversing the second gesture. In other words, gesture detection module 234 may output, for display at display component 206, a graphical element that marks the path taken by tactile device 120 during the second gesture. The graphical element may be of any suitable style, including a solid path, a dotted or dashed path, or some other patterned path, any of which may have varying line weights.

Gesture detection module 234 may determine whether the second gesture was initiated within a second target starting area of presence-sensitive input component 210 and was terminated in a second target termination area of presence-sensitive input component 210. The second target starting area may be an area on presence-sensitive input component 210 that corresponds to an upper-right corner of the graphical user interface. Further, the second target termination area may be an area on presence-sensitive input component 210 that corresponds to a lower-left corner of the graphical user interface. For example, gesture detection module 234 may receive an indication of the second gesture that traveled from the upper-right corner of presence-sensitive input component 210 to the lower-left corner of presence-sensitive input component 210, as described above. Gesture detection module 234 may determine whether the second gesture begins in a second target starting area of presence-sensitive input component 210 (e.g., the upper-right corner). If the second gesture begins in the second target starting area, gesture detection module 234 may then determine whether the termination point of the second gesture is in a second target termination area of presence-sensitive input component 210 (e.g., the lower-left corner) diagonal of the beginning point of the second gesture.

For each of the first gesture and the second gesture, the corner areas may be arranged such that each of the first gesture and the second gesture span at least a particular distance. In other words, the corner areas may be arranged and sized such that a particular distance separates a particular corner area from the diagonally-situated corner area. For example, the corner areas may be situated such that each of the first gesture and the second gesture span a distance greater than or equal to 75% of the length of a diagonal measurement of presence-sensitive input component 210. In other examples, the percentage threshold may be greater than or less than 75% of the diagonal measurement. In still other examples, rather than a percentage of the diagonal measurement, each of the first gesture and the second gesture may have to span a fixed distance, such as 3 or 4 inches.

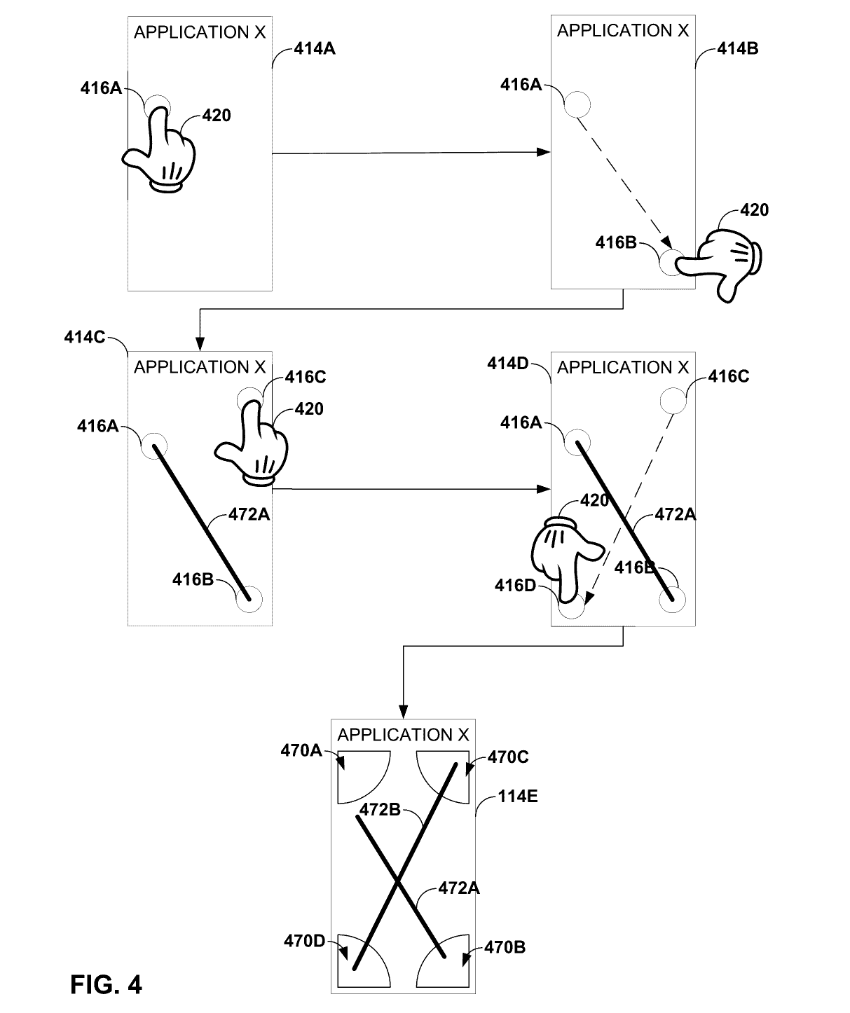

As shown in greater detail in the description of FIG. 4 below, tactile device 120 may initiate and/or terminate the first gesture and/or the second gesture in an area of presence-sensitive input component 210 proximate to the respective corner area but not actually inside the respective corner area. For instance, tactile device 120 may initiate the first gesture slightly outside of the first target starting area but terminate the first gesture in the first target termination area. Tactile device 120 may also initiate the second gesture inside the second target starting area and terminate the second gesture in the second target termination area. In such an example, gesture detection module 234 may determine that the user possibly intended to cease execution of the application, but also may have intended to perform a different action or unintentionally formed a compound crisscross gesture. Since the intention is more unclear, application management module 238 may output an additional respective graphical element that substantially covers a respective portion of the graphical user interface on display component 206 that corresponds to each of the first target starting area, the first target termination area, the second target starting area, and the second target termination area of presence-sensitive input component 210. By outputting these additional graphical elements, application management module 238 outlines to the user where tactile device 120 must initiate and terminate each gesture in order to cease the execution of application 208A. By constraining the gestures to the corner areas of presence-sensitive input component 210 and clarifying the possible intentions of the user when the gestures begin and/or terminate outside of the corner areas, computing device 204 reduces the number of instances where a user may accidentally cease the execution of the currently executing application. Computing device 204 further uses the constraints to provide the user with explicit indications of where the user must begin and terminate each gesture if the user does intend to cease the output of the graphical user interface of the application.

Timing module 236 may further determine whether an amount of time between termination of the first gesture and initiation of the second gesture satisfies a timeout threshold. The timeout threshold, in some examples, may be 0.2 seconds, 0.5 seconds, 1 second, etc. In other examples, however, the timeout threshold may be less than 0.2 seconds or greater than 1 second.

The first gesture (from the first target starting area to the first target termination area) and the second gesture (from the second target starting area different from the first target starting and first target termination areas to the second target termination area) may form a gesture similar to the shape of an ‘X’. However, many applications may include functionality for a gesture from a corner of presence-sensitive input component 210 to a diagonal corner of presence-sensitive input component. By including the timeout threshold, components of gesture module 212 may more accurately discern an intent of a user operating computing device 204. For instance, if timing module 235 determines that the amount of time between the termination of the first gesture and the initiation of the second gesture satisfies the timeout threshold, gesture module 212 may determine that the user intended to cease the output of the graphical user interface of application 208A. Conversely, if timing module 235 determines that the amount of time between the two gestures does not satisfy the timeout threshold, such as if the amount of time is greater than the timeout threshold, gesture module 212 may determine that the gestures were not input with the intention of ceasing the output of the graphical user interface of application 208A.

Responsive to determining that the amount of time satisfies the timeout threshold, application management module 238 may cause processors 240 to cease the output of the graphical user interface of application 208A at computing device 204. For example, after the conclusion of the second gesture where tactile device 120 is lifted off of presence-sensitive input component 210, if gesture detection module 234 and timing module 236 determine that the above constraints are satisfied, application management module 238 may cause processors 240 of computing device 204 to cease the execution of all operations for application 208A.

In some examples, responsive to the termination of the second gesture and when the first gesture and the second gesture satisfy the constraints outlined above, application management module 238 may cease the output of the graphical user interface for application 208A using display component 206. Application management module 238 may further output, for display at display component 206, a second graphical user interface different from the first graphical user interface. For instance, application management module 238 of computing device 204 may output a graphical user interface of a second application in the list of applications determined above, such as application 208B, using display component 206. In another example, application management module 238 of computing device 204 may output a home screen using display component 206.

In some examples, in addition to ceasing the output of the graphical user interface, application management module 238 may further cease executing application 208A. In some devices, even though a graphical user interface is not being output on the display, the device may still process certain operations dealing with the application. In response to removing the graphical user interface from display, application management module 238 may cease executing all other operations of application 208A, further reducing the processing power consumed within computing device 204.

In some examples, before ceasing the execution of application 208A, application management module 238 may first output, for display using display component 206, a request for confirmation to cease execution of application 208A. As described above, some applications may include local functionality in response to receiving a compound gesture similar to the one described herein. As such, gesture detection module 234 may detect a compound gesture that satisfies both the gesture constraints and the timing constraint for ceasing the execution of application 208A, but the user may instead be intending to perform a different function local to application 208A. To further reduce the number of false terminations, application management module 238 may output a confirmation prompt using display component 206 to confirm that the user intends to cease the output of the graphical user interface of application 208A. Responsive to receiving the confirmation to cease the output of the graphical user interface application 208A, application management module 208A may cause processors 240 to cease the output of the graphical user interface of application 208A on computing device 204. In other instances, the user may instead confirm that the user does not intend to close application 208A. In such instances, application management module 238 may cause processors 240 to continue executing application 208A on computing device 204 and display component 206 may continue outputting the initial graphical user interface. In some further examples of such instances, to allow the user to uninterruptedly utilize the local functionality of the compound gesture in application 208A, gesture detection module 234 may stop making determinations with regards to the compound gesture such that the user may input the compound gesture in the future without ceasing the output of the graphical user interface of application 208A and without outputting the confirmation prompt. Gesture detection module 234 may stop making these determinations permanently or only temporarily, and may stop making these determinations for only application 208A or for any application executing on computing device 204.

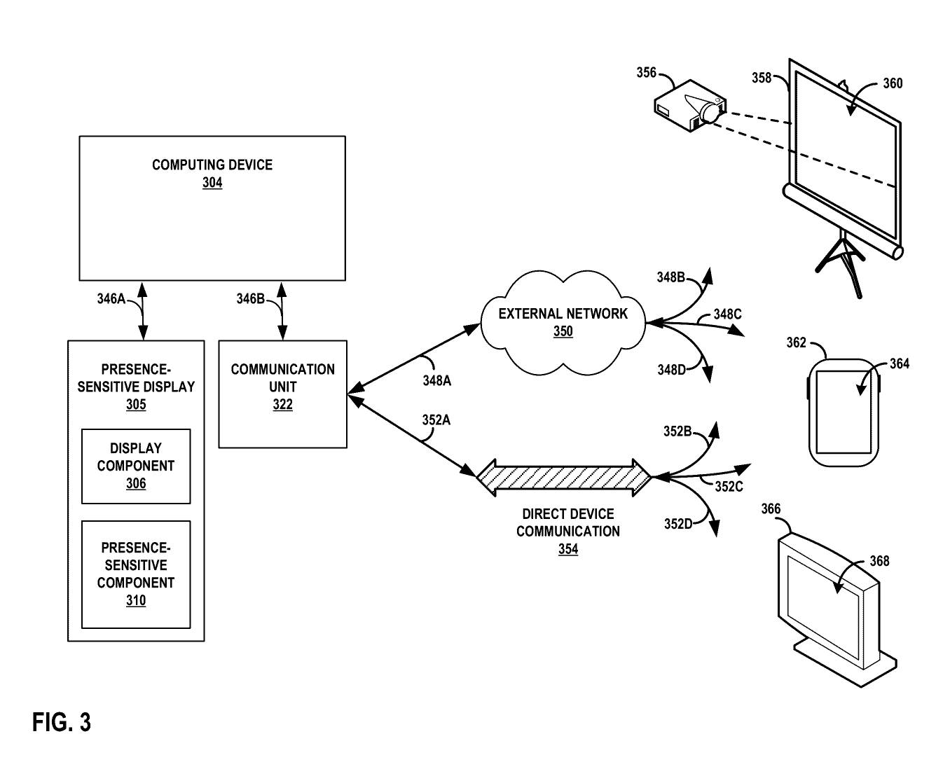

FIG. 3 is a block diagram illustrating an example computing device 304 that outputs screen content for display at a remote device, in accordance with one or more techniques of the present disclosure. Screen content, generally, may include any visual information that may be output for display, such as text, images, a group of moving images, etc. The example shown in FIG. 3 includes a computing device 304, presence-sensitive display 305, communication unit 322, projector 356, projector screen 358, mobile device 362, and visual display component 366. Although shown for purposes of example in FIGS. 1 and 2 as a stand-alone computing device 104 and 204, respectively, a computing device such as computing device 304 may, generally, be any component or system that includes a processor or other suitable computing environment for executing software instructions and, for example, need not include a display component.

As shown in the example of FIG. 3, computing device 304 may be a processor that includes functionality as described with respect to processor 240 in FIG. 2. In such examples, computing device 304 may be operatively coupled to presence-sensitive display 305 by a communication channel 346A, which may be a system bus or other suitable connection. Computing device 304 may also be operatively coupled to communication unit 322, further described below, by a communication channel 346B, which may also be a system bus or other suitable connection. Although shown separately as an example in FIG. 3, computing device 304 may be operatively coupled to presence-sensitive display 205 and communication unit 322 by any number of one or more communication channels.

In other examples, such as illustrated previously by computing device 104 in FIG. 1 and computing device 204 in FIG. 2, a computing device may refer to a portable or mobile device such as a mobile phone (including smart phone), laptop computer, smartwatch, etc. In some examples, a computing device may be a desktop computer, tablet computer, smart television platform, gaming console, remote controller, electronic camera, personal digital assistant (PDA), server, mainframe, etc.

Presence-sensitive display 305, like presence-sensitive display 105 of FIG. 1, may include a display component (e.g., display component 306) and a presence-sensitive input component (e.g., presence-sensitive input component 310). Presence-sensitive display 305 may have functionality similar to presence-sensitive display 105 of FIG. 1 and presence-sensitive display 205 of FIG. 2. Display component 306 may, for example, receive data from computing device 304 and display the screen content. Display component may also have functionality similar to display component 206 of FIG. 2. In some examples, presence-sensitive input component 310 may determine one or more user inputs (e.g., continuous gestures, multi-touch gestures, single-touch gestures, etc.) at presence-sensitive display 305 using capacitive, inductive, and/or optical recognition techniques and send indications of such user input to computing device 304 using communication channel 346A. Presence-sensitive input component 310 may also have functionality similar to presence-sensitive input component 210 of FIG. 2. In some examples, presence-sensitive input component 310 may be physically positioned on top of display component 306 such that, when a user positions an input unit over a graphical element displayed by display component 306, the location at which presence-sensitive input component 310 corresponds to the location of display component 306 at which the graphical element is displayed. In other examples, presence-sensitive input component 310 may be positioned physically apart from display component 306, and locations of presence-sensitive input component 310 may correspond to locations of display component 306, such that input can be made at presence-sensitive input component 310 for interacting with graphical elements displayed at corresponding locations of display component 306.

As shown in FIG. 3, computing device 304 may also include and/or be operatively coupled with communication unit 322. Communication unit 322 may include functionality of communication unit 222 as described in FIG. 2. Examples of communication unit 322 may include a network interface card, an Ethernet card, an optical transceiver, a radio frequency transceiver, or any other type of device that can send and receive information. Other examples of such communication units may include Bluetooth, 3G, and Wi-Fi radios, Universal Serial Bus (USB) interfaces, etc. Computing device 304 may also include and/or be operatively coupled with one or more other devices, e.g., input components, output components, memory, storage devices, etc. that are not shown in FIG. 3 for purposes of brevity and illustration.

FIG. 3 also illustrates a projector 356 and projector screen 358. Other such examples of projection devices may include electronic whiteboards, holographic display components, and any other suitable devices for displaying screen content. Projector 356 and projector screen 358 may include one or more communication units that enable the respective devices to communicate with computing device 304. In some examples, the one or more communication units may enable communication between projector 356 and projector screen 358. Projector 356 may receive data from computing device 304 that includes screen content. Projector 356, in response to receiving the data, may project the screen content onto projector screen 358. In some examples, projector 356 may determine one or more user inputs (e.g., continuous gestures, multi-touch gestures, single-touch gestures, etc.) at projector screen using optical recognition or other suitable techniques and send indications of such user input using one or more communication units to computing device 304. In such examples, projector screen 358 may be unnecessary, and projector 356 may project screen content on any suitable medium and detect one or more user inputs using optical recognition or other such suitable techniques.

Projector screen 358, in some examples, may include a presence-sensitive display 360. Presence-sensitive display 360 may include a subset of functionality or all of the functionality of display component 106 as described in this disclosure. In some examples, presence-sensitive display 360 may include additional functionality. Projector screen 358 (e.g., an electronic whiteboard), may receive data from computing device 304 and display the screen content. In some examples, presence-sensitive display 360 may determine one or more user inputs (e.g., continuous gestures, multi-touch gestures, single-touch gestures, etc.) at projector screen 358 using capacitive, inductive, and/or optical recognition techniques and send indications of such user input using one or more communication units to computing device 304.

FIG. 3 also illustrates mobile device 362 and visual display component 366. Mobile device 362 and visual display component 366 may each include computing and connectivity capabilities. Examples of mobile device 362 may include e-reader devices, convertible notebook devices, hybrid slate devices, etc. Examples of visual display component 366 may include other semi-stationary devices such as televisions, computer monitors, etc. As shown in FIG. 3, mobile device 362 may include a presence-sensitive display 364. Visual display component 366 may include a presence-sensitive display 368. Presence-sensitive displays 364, 368 may include a subset of functionality or all of the functionality of presence-sensitive display 305 as described in this disclosure. In some examples, presence-sensitive displays 364, 368 may include additional functionality. In any case, presence-sensitive display 364, for example, may receive data from computing device 304 and display the screen content. In some examples, presence-sensitive display 368 may determine one or more user inputs (e.g., continuous gestures, multi-touch gestures, single-touch gestures, etc.) at projector screen using capacitive, inductive, and/or optical recognition techniques and send indications of such user input using one or more communication units to computing device 304.

As described above, in some examples, computing device 304 may output screen content for display at presence-sensitive display 305 that is coupled to computing device 304 by a system bus or other suitable communication channel. Computing device 304 may also output screen content for display at one or more remote devices, such as projector 356, projector screen 358, mobile device 362, and visual display component 366. For instance, computing device 304 may execute one or more instructions to generate and/or modify screen content in accordance with techniques of the present disclosure. Computing device 304 may output the data that includes the screen content to a communication unit of computing device 304, such as communication unit 322. Communication unit 322 may send the data to one or more of the remote devices, such as projector 356, projector screen 358, mobile device 362, and/or visual display component 366. In this way, computing device 304 may output the screen content for display at one or more of the remote devices. In some examples, one or more of the remote devices may output the screen content at a display component that is included in and/or operatively coupled to the respective remote devices.

In some examples, computing device 304 may not output screen content at presence-sensitive display 305 that is operatively coupled to computing device 304. In other examples, computing device 304 may output screen content for display at both a presence-sensitive display 305 that is coupled to computing device 304 by communication channel 346A, and at one or more remote devices. In such examples, the screen content may be displayed substantially contemporaneously at each respective device. For instance, some delay may be introduced by the communication latency to send the data that includes the screen content to the remote device. In some examples, screen content generated by computing device 304 and output for display at presence-sensitive display 305 may be different than screen content display output for display at one or more remote devices.

Computing device 304 may send and receive data using any suitable communication techniques. For example, computing device 304 may be operatively coupled to external network 350 using network link 348A. Each of the remote devices illustrated in FIG. 3 may be operatively coupled to external network 350 by one of respective network links 348B, 348C, and 348D. External network 350 may include network hubs, network switches, network routers, etc., that are operatively inter-coupled thereby providing for the exchange of information between computing device 304 and the remote devices illustrated in FIG. 3. In some examples, network links 348A-348D may be Ethernet, ATM or other network connections. Such connections may be wireless and/or wired connections.

In some examples, computing device 304 may be operatively coupled to one or more of the remote devices included in FIG. 3 using direct device communication 354. Direct device communication 354 may include communications through which computing device 304 sends and receives data directly with a remote device, using wired or wireless communication. That is, in some examples of direct device communication 354, data sent by computing device 304 may not be forwarded by one or more additional devices before being received at the remote device, and vice-versa. Examples of direct device communication 354 may include Bluetooth, Near-Field Communication, Universal Serial Bus, WiFi, infrared, etc. One or more of the remote devices illustrated in FIG. 3 may be operatively coupled with computing device 304 by communication links 352A-352D. In some examples, communication links 352A-352D may be connections using Bluetooth, Near-Field Communication, Universal Serial Bus, infrared, etc. Such connections may be wireless and/or wired connections.

As discussed above, computing device 304 may output, for display at a display component (e.g., presence-sensitive display 305, projector 356, mobile device 362, or visual display component 366) a graphical user interface of an application currently executing on computing device 304. The display component may detect a first gesture and a second gesture. Computing device 304 may determine whether the first gesture is initiated within a first target starting area of the display component and terminates in a first target termination area of the display component diagonal from the first target starting area. Computing device 304 may also determine whether the second gesture is initiated in a second target starting area of the display component and terminates in a second target termination area of the display component diagonal from the second target starting area. In some examples, the second target starting area is different from the first target starting and first target termination areas. Computing device 304 may further determine whether an amount of time between termination of the first gesture and initiation of the second gesture satisfies a timeout threshold. Responsive to determining that the amount of time satisfies the timeout threshold, that the first gesture is initiated within the first target starting area and terminates in the first target termination area and that the second gesture is initiated within the second target starting area and terminates in the second target termination area, computing device 304 may cease the output of the graphical user interface of the application on computing device 304.

FIG. 4 is a conceptual diagram illustrating an example system including a computing device that receives a pair of gestures that do not completely satisfy the requirements for terminating an application executing on the computing device, in accordance with one or more aspects of the present disclosure. Graphical user interfaces 414A-414E may be graphical user interfaces output by a presence-sensitive display, such as presence-sensitive display 105 of FIG. 1, presence-sensitive display 205 of FIG. 2, or presence-sensitive display 305 of FIG. 3, executing on a computing device, such as computing device 104 of FIG. 1, computing device 204 of FIG. 2, or computing device 304 of FIG. 3.

The presence-sensitive display may detect a first gesture. For example, as shown in interface 414A, the presence-sensitive display may detect an initiation of a first gesture from tactile device 420 at gesture point 416A. The first gesture, as shown in interface 414B, may include moving tactile device 420 along the presence-sensitive display from gesture point 416A to 416B. In other examples, the first gesture may originate at a point on the presence-sensitive display different than gesture point 416A and/or terminate at a point on the presence-sensitive display different than gesture point 416B. Responsive to detecting the first gesture, the computing device may output, for display at the presence sensitive display, first trail 472A substantially traversing the first gesture. First trail 472A may be a graphical element that marks the path taken by tactile device 420 during the first gesture from gesture point 416A to gesture point 416B. First trail 472A may be of any suitable style, including a solid path, a dotted or dashed path, or some other patterned path, any of which may have varying line weights. Alternatively, no trail may be shown.

The computing device may determine whether the first gesture was initiated within a first target starting area of the presence-sensitive display and was terminated in a first target termination area of the presence-sensitive display. For example, the computing device may receive an indication of the first gesture that traveled from gesture point 416A to gesture point 416B and the second gesture from gesture point 416C to gesture point 416D. The computing device may determine whether gesture point 416A is in a first target starting area of the presence-sensitive display. If gesture point 416A is in the first target starting area, the computing device may then determine whether the termination point of gesture point 416B is in a first target termination area diagonal of gesture point 416A.

The presence-sensitive display may detect a second gesture. For example, as shown in interface 414C, the presence-sensitive display may detect an initiation of a second gesture from tactile device 420 at gesture point 416C. The second gesture, as shown in interface 414D, may include moving tactile device 420 along the presence-sensitive display from gesture point 416C to gesture point 416D. In other examples, the second gesture may originate in a point on the presence-sensitive display different than gesture point 416C and/or terminate at a point on the presence-sensitive display different than gesture point 416D. Responsive to detecting the second gesture, the computing device may output, for display at the presence sensitive display, second trail 472B substantially traversing the second gesture. Second trail 472B may be a graphical element that marks the path taken by tactile device 420 during the second gesture from gesture point 416C to gesture point 416D. Second trail 472B may be of any suitable style, including a solid path, a dotted or dashed path, or some other patterned path, any of which may have varying line weights. Alternatively, no trail may be shown, or the second trail 472B may be shown only if the gesture point 416C was initiated within a timeout threshold of the release of gesture point 416B.

The computing device may also determine whether the second gesture was initiated within a second target starting area of the presence-sensitive display and was terminated in a second target termination area of the presence-sensitive display. For the second gesture, the second target starting area is different than the first target starting and first target termination area. Gesture module 112 may also determine whether gesture point 416C is in the second target starting area of the presence-sensitive display. If gesture point 416C is in the second target starting area, the computing device may then determine whether the termination point of gesture point 416D is in the second target termination area diagonal of gesture point 416C.

In the example of FIG. 4, although gesture point 416B is a termination point in the first target termination area of the presence-sensitive display, gesture point 416C is an initiation point in the second target starting area of the presence-sensitive display, and gesture point 416D is a termination point in the second target termination area of the presence-sensitive display, gesture point 416A is not in the first target starting area. Gesture point 416A is, however, at a point proximate to the first target starting area, albeit not inside the first target starting area. In other words, tactile device 420 initiated the first gesture at gesture point 416A which is near the first target starting area, but not inside the first target starting area. As such, the constraints to cease the execution of the currently executing application are not satisfied by the compound gesture indicated by gesture points 416A-416D.

In such an example, the computing device may determine that the user possibly intended to cease execution of the application, but also may have intended to perform a different action. Since the intention is more unclear, the presence-sensitive display may output additional graphical elements 470A-470D that substantially cover a respective portion of the graphical user interface on the presence-sensitive display that corresponds to each of the first target starting area, the first target termination area, the second target starting area, and the second target termination area of the presence-sensitive display. For instance, graphical element 470A may correspond to the first target starting area, graphical element 470B may correspond to the first target termination area, graphical element 470C may correspond to the second target starting area, and graphical element 470D may correspond to the second target termination area. By outputting graphical elements 470A-470D, the computing device outlines to the user where tactile device 420 must initiate and terminate each gesture in order to cease the execution of the currently executing application. By constraining the gestures to the corner areas of the presence-sensitive display depicted by graphical elements 470A-470D and clarifying the possible intentions of the user when the gestures begin and/or terminate outside of the corner areas depicted by graphical elements 470A-470D, the computing device reduces the number of instances where a user may accidentally cease the output of the graphical user interface of the currently executing application. The computing device further uses the constraints to provide the user with explicit indications of where the user must begin and terminate each gesture if the user does intend to cease the execution of the currently executing application.

In some examples, the computing device may further receive a third gesture that is initiated within the corner area depicted by graphical element 470A and is terminated within the corner area depicted by graphical element 470B. Further, the computing device may receive a fourth gesture that is initiated within the corner area depicted by graphical element 470C and is terminated within the corner area depicted by graphical element 470D. As long as the compound gesture made up of the third and fourth gesture satisfies the time threshold constraint described herein, the computing device may then cease the output of the graphical user interface of the application at the computing device.

In the example of FIG. 4, graphical elements 470A-470D that represent the four target areas are quadrant-shaped with the squared corner being proximate to the corner of the presence-sensitive input device or a graphical user interface displayed on the presence-sensitive input device. In various instances, the target areas may be shaped differently. For instance, the target areas may be larger or smaller. In other instances, the corner areas may have a different shape, such as a square, a rectangle, a circle, or any other shape that adequately represents a target area of the presence-sensitive input device or a graphical user interface displayed on the presence-sensitive input device. In various instances, the target areas may be shaped in a circle with a 150 px radius.

In some instances, one or more of the target areas may be in a location of the presence-sensitive input device or a graphical user interface displayed on the presence-sensitive input device that is further away from the corners of the presence-sensitive input device or a graphical user interface displayed on the presence-sensitive input device than depicted in FIG. 4. For instance, graphical elements 470A and 470C may be vertically positioned closer to the middle of the presence-sensitive input device or a graphical user interface displayed on the presence-sensitive input device, with graphical elements 470B and 470D being located proximate to the bottom corners of the presence-sensitive input device or a graphical user interface displayed on the presence-sensitive input device. In other instances, graphical elements 470A and 470C may be vertically positioned proximate to the top corners of the presence-sensitive input device or a graphical user interface displayed on the presence-sensitive input device, with graphical elements 470B and 470D being located closer to the middle of the presence-sensitive input device or a graphical user interface displayed on the presence-sensitive input device

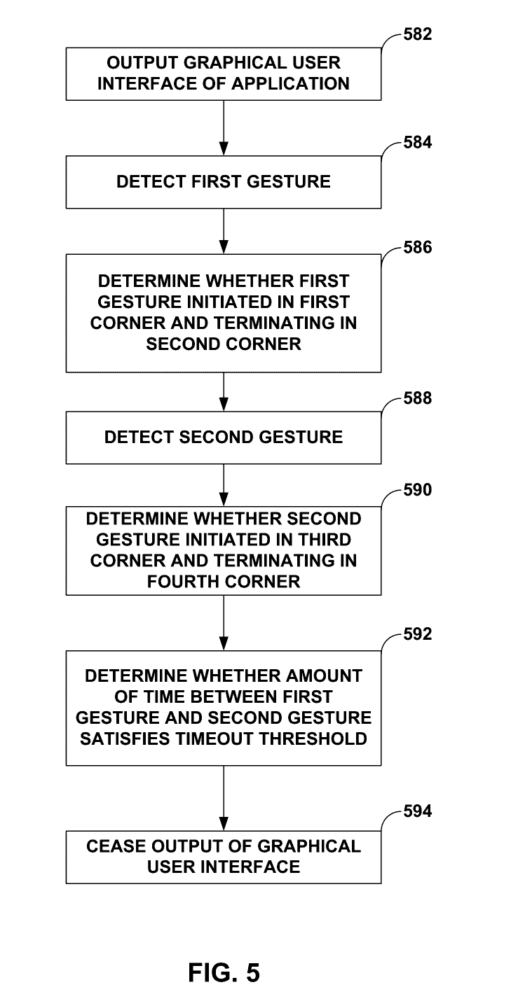

FIG. 5 is a flow chart illustrating example operations of a computing device that implements techniques for terminating an application executing on the computing device, in accordance with one or more aspects of the present disclosure. The techniques of FIG. 5 may be performed by one or more processors of a computing device, such as computing device 104, 204, and 304 illustrated in FIG. 1, FIG. 2, and FIG. 3, respectively. For purposes of illustration, the techniques of FIG. 5 are described within the context of computing device 104 of FIG. 1, although computing devices having configurations different than that of computing device 104 may perform the techniques of FIG. 5.

In accordance with techniques of the current disclosure, a module (e.g., application management module 138) of a computing device (e.g., computing device 104) may output 582, via a presence-sensitive display (e.g., presence-sensitive display 105), a graphical user interface (e.g., graphical user interface 114A) of an application (e.g., application 108A) currently executing on computing device 104. Application 108A may be any application that can execute on computing device 104, such as a browser application, a gaming application, a banking application, or any other application suited for execution on computing device 104.

Presence-sensitive display 105 may detect 584 a first gesture. For example, as shown in interface 114A, presence-sensitive display 105 may detect an initiation of a first gesture from a tactile device (e.g., tactile device 120) at a first gesture point (e.g., gesture point 116A). The first gesture may include moving tactile device 120 along presence-sensitive display 105 from gesture point 116A to a second gesture point (e.g., gesture point 116B) diagonal from gesture point 116A. In some examples, responsive to detecting the first gesture, gesture module 112 may output, for display at presence-sensitive display 105, a first trail (e.g., first trail 472A of FIG. 4) substantially traversing the first gesture. In other words, gesture module 112 may output, for display at presence-sensitive display 105, a graphical element that marks the path taken by tactile device 120 during the first gesture. The graphical element may be of any suitable style, including a solid path, a dotted or dashed path, or some other patterned path, any of which may have varying line weights.

A second module (e.g., gesture module 112) may determine whether the first gesture was initiated within a first target starting area of presence-sensitive display 105 and was terminated in a first target termination area of presence-sensitive display 105 (586). The first target starting area may be an area on presence-sensitive display 105 that corresponds to an upper-left corner of the graphical user interface. Further, the first target termination area may be an area on presence-sensitive display 105 that corresponds to a lower-right corner of the graphical user interface. For example, gesture module 112 may receive an indication of the first gesture that traveled from the upper-left corner of presence-sensitive display 105 to the lower-right corner of presence-sensitive display 105, as described above. Gesture module 112 may determine whether the first gesture begins in a first target starting area of presence-sensitive display 105 (e.g., the upper-left corner). If the first gesture begins in the first target starting area, gesture module 112 may then determine whether the termination point of the first gesture is in a first target termination area of presence-sensitive display 105 (e.g., the lower-right corner) diagonal of the beginning point of the first gesture.

Presence-sensitive display 105 may detect a second gesture (588). For example, presence-sensitive display may detect an initiation of a second gesture from tactile device 120 at a third gesture point (e.g., gesture point 116C) different from gesture points 116A and 116B. The second gesture may include moving tactile device 120 along presence-sensitive display 105 from gesture point 116C to a fourth gesture point (e.g., gesture point 116D) diagonal from gesture point 116C. In some examples, responsive to detecting the second gesture, gesture module 112 may output, for display at presence-sensitive display 105, a second trail substantially traversing the second gesture. In other words, application management module 138 may output, for display at presence-sensitive display 105, a graphical element that marks the path taken by tactile device 120 during the second gesture. The graphical element may be of any suitable style, including a solid path, a dotted or dashed path, or some other patterned path, any of which may have varying line weights.

Gesture module 112 may determine whether the second gesture was initiated within a second target starting area of presence-sensitive display 105 and was terminated in a second target termination area of presence-sensitive display 105 (590). The second target starting area may be an area on presence-sensitive display 105 that corresponds to an upper-right corner of the graphical user interface. Further, the second target termination area may be an area on presence-sensitive display 105 that corresponds to a lower-left corner of the graphical user interface. For example, gesture module 112 may receive an indication of the second gesture that traveled from the upper-right corner of presence-sensitive display 105 to the lower-left corner of presence-sensitive display 105, as described above. Gesture module 112 may determine whether the second gesture begins in a second target starting area of presence-sensitive display 105 (e.g., the upper-right corner). If the second gesture begins in the second target starting area, gesture module 112 may then determine whether the termination point of the second gesture is in a second target termination area of presence-sensitive display 105 (e.g., the lower-left corner) diagonal of the beginning point of the second gesture.

In some examples, for each of the first gesture and the second gesture, the corner areas may be arranged such that each of the first gesture and the second gesture span at least a particular distance. In other words, the corner areas may be arranged and sized such that a particular distance separates a particular corner area from the diagonally-situated corner area. For example, the corner areas may be situated such that each of the first gesture and the second gesture span a distance greater than or equal to 75% of the length of a diagonal measurement of presence-sensitive display 105. In other examples, the percentage threshold may be greater than or less than 75% of the diagonal measurement. In still other examples, rather than a percentage of the diagonal measurement, each of the first gesture and the second gesture may have to span a fixed distance, such as 3 or 4 inches.

As shown in greater detail in the description of FIG. 4 above, tactile device 120 may initiate and/or terminate the first gesture and/or the second gesture in an area of presence-sensitive display 105 proximate to the respective corner area but not actually inside the respective corner area. For instance, tactile device 120 may terminate the second gesture slightly outside of the second target termination area but initiate the second gesture in the second target starting area. Tactile device 120 may also initiate the first gesture inside the first target starting area and terminate the first gesture in the first target termination area. In such an example, gesture module 112 may determine that the user possibly intended to cease execution of the application, but also may have intended to perform a different action. Since the intention is more unclear, gesture module 112 may output an additional respective graphical element that substantially covers a respective portion of the graphical user interface on presence-sensitive display 205 that corresponds to each of the first target starting area, the first target termination area, the second target starting area, and the second target termination area of presence-sensitive display 105. By outputting these additional graphical elements, gesture module 112 outlines to the user where tactile device 120 must initiate and terminate each gesture in order to cease the execution of application 208A. By constraining the gestures to the corner areas of presence-sensitive display 105 and clarifying the possible intentions of the user when the gestures begin and/or terminate outside of the corner areas, computing device 104 reduces the number of instances where a user may accidentally cease the execution of the currently executing application. Computing device 104 further uses the constraints to provide the user with explicit indications of where the user must begin and terminate each gesture if the user does intend to cease the execution of the currently executing application.

Gesture module 112 may further determine whether an amount of time between termination of the first gesture and initiation of the second gesture satisfies a timeout threshold (592). The timeout threshold, in some examples, may be 0.2 seconds, 0.5 seconds, 1 second, etc. In other examples, however, the timeout threshold may be less than 0.2 seconds or greater than 1 second.

The first gesture (from the first target starting area to the first target termination area) and the second gesture (from the second target starting area different from the first target starting and first target termination areas to the second target termination area) may form a compound gesture similar to the shape of an ‘X’. However, many applications may include functionality for a gesture from a corner of presence-sensitive display 105 to a diagonal corner of presence-sensitive input component. By including the timeout threshold, components of gesture module 112 may more accurately discern an intent of a user operating computing device 104. For instance, if gesture module 112 determines that the amount of time between the termination of the first gesture and the initiation of the second gesture satisfies the timeout threshold, gesture module 112 may determine that the user intended to terminate the execution of application 108A. Conversely, if gesture module 112 determines that the amount of time between the two gestures does not satisfy the timeout threshold, such as if the amount of time is greater than the timeout threshold, gesture module 112 may determine that the gestures were not input with the intention of terminating the execution of application 108A.

Responsive to determining that the amount of time satisfies the timeout threshold, application management module 138 may cause computing device 104 to cease the output of the graphical user interface of application 108A (594). For example, after the conclusion of the second gesture where tactile device 120 is lifted off of presence-sensitive display 105, if gesture module 112 determines that the above constraints are satisfied, application management module 138 may cause computing device 104 to cease the output of the graphical user interface of application 108A. In some further examples, responsive to determining that the amount of time satisfies the timeout threshold, application management module 138 may cause computing device 104 to cease the execution of all operations for application 108A.

In some examples, upon the termination of the second gesture and when the first gesture and the second gesture satisfy the constraints outlined above, application management module 138 may output, for display at presence-sensitive display 105, a second graphical user interface different from the first graphical user interface. For instance, application management module 138 of computing device 104 may output a graphical user interface of a second application in the list of applications determined above, such as application 108B, using presence-sensitive display 105. In another example, application management module 138 of computing device 104 may output a home screen using presence-sensitive display 105.

In some examples, before ceasing the output of the graphical user interface of application 108A, application management module 138 may first output, for display using presence-sensitive display 105, a request for confirmation to cease the output of the graphical user interface of application 108A. As described above, some applications may include local functionality in response to receiving a compound gesture similar to the one described herein. As such, gesture module 112 may detect a compound gesture that satisfies both the gesture constraints and the timing constraint for ceasing the execution of application 108A, but the user may instead be intending to perform a different function local to application 108A. To further reduce the number of false terminations, application management module 138 may output a confirmation prompt using presence-sensitive display 105 to confirm that the user intends to cease the output of the graphical user interface of application 108A. Responsive to receiving the confirmation to cease the output of the graphical user interface of application 108A, application management module 138 may cause computing device 104 to cease the output of the graphical user interface of application 108A. In other instances, the user may instead confirm that the user does not intend to close application 108A. In such instances, application management module 138 may cause computing device 104 to continue executing application 108A and presence-sensitive display 105 may continue outputting the initial graphical user interface. In some further examples of such instances, to allow the user to uninterruptedly utilize the local functionality of the compound gesture in application 108A, gesture module 112 may stop making determinations with regards to the compound gesture such that the user may input the compound gesture in the future without ceasing the execution of application 108A and without outputting the confirmation prompt. Gesture module 112 may stop making these determinations permanently or only temporarily, and may stop making these determinations for only application 108A or for any application executing on computing device 104.

By implementing techniques of this disclosure, a computing device, such as computing device 104, may provide an efficient and intuitive method of terminating the execution of an application on the computing device. Including an additional element within a graphical user interface leads to a more crowded depiction of the graphical user interface, as the additional element must be incorporated somehow. In other examples, a user must enter input first that changes the existing graphical user interface, which adds more time and operations to the process of terminating an application. Rather than requiring an additional element within a graphical user interface or requiring a change in the graphical user interface in order to terminate an application, requiring the input of a gesture similarly shaped to an ‘X’ under a predefined timeout threshold provides the user with the capability to quickly terminate the execution of an application executing on the computing device while reducing the processing power necessary to change the graphical user interface. Further, the compound for terminating the application may reduce the amount of time the computing device must execute the application compared to the example where the graphical user interface must change, which may further reduce the processing power required of the computing device and saving battery power of the computing device. Techniques of this disclosure further allow the graphical user interface to remain unchanged and uncluttered by the addition of an element that can be used to terminate the application.

### Example 1

A method comprising: outputting, by a computing device and for display, a graphical user interface of an application currently executing at the computing device; detecting, by a presence-sensitive input device operably coupled to the computing device, a first gesture; determining, by the computing device, whether the first gesture is initiated within a first target starting area of the presence-sensitive input device and terminates in a first target termination area of the presence-sensitive input device diagonal from the first target starting area; detecting, by the presence-sensitive input device, a second gesture; determining, by the computing device, whether the second gesture is initiated in a second target starting area of the presence-sensitive input device and terminates in a second target termination area of the presence-sensitive input device diagonal from the second target starting area, wherein the second target starting area is different from the first target starting and first target termination areas; determining, by the computing device, whether an amount of time between termination of the first gesture and initiation of the second gesture satisfies a timeout threshold; and responsive to determining that the amount of time satisfies the timeout threshold, that the first gesture is initiated within the first target starting area and terminates in the first target termination area and that the second gesture is initiated within the second target starting area and terminates in the second target termination area, ceasing the output of the graphical user interface of the application at the computing device.

### Example 2

The method of example 1, the method further comprising: responsive to determining that one or more of the first gesture is initiated in an area proximate to the first target starting area but not in the first target starting area, the first gesture terminates in an area proximate to the first target termination area but not in the first target termination area, the second gesture is initiated in an area proximate to the second target starting area but not in the second target starting area, or the second gesture terminates in an area proximate to the second target termination area but not in the second target termination area: outputting, by the computing device and for display, a respective graphical element that substantially covers a respective portion of the graphical user interface that corresponds to each of the first target starting area, the first target termination area, the second target starting area, and the second target termination area.

### Example 3

The method of any of examples 1-2, wherein the graphical user interface of the application currently executing at the computing device is a first graphical user interface and wherein the application is a first application, the method further comprising: outputting, by the computing device and for display, a second graphical user interface different from the first graphical user interface.

### Example 4

The method of any of examples 1-3, wherein the graphical user interface encompasses the entire display.

### Example 5

The method of any of examples 1-4, further comprising, responsive to determining that the amount of time satisfies the timeout threshold, that the first gesture is initiated within the first target starting area and terminates in the first target termination area and that the second gesture is initiated within the second target starting area and terminates in the second target termination area, ceasing execution of the application at the computing device.

### Example 6

The method of any of examples 1-5, wherein the first target starting area is an area on the presence-sensitive input device that corresponds to an upper-left corner of the graphical user interface, wherein the first target termination area is an area on the presence-sensitive input device that corresponds to a lower-right corner of the graphical user interface, wherein the second target starting area is an area on the presence-sensitive input device that corresponds to an upper-right corner of the graphical user interface, and wherein the second target termination area is an area on the presence-sensitive input device that corresponds to a lower-left corner of the graphical user interface.

### Example 7

The method of any of examples 1-6, wherein the first gesture and the second gesture each span a distance greater than or equal to 75% of the length of a diagonal measurement of the presence-sensitive input device.

### Example 8

The method of any of examples 1-7, wherein ceasing the output of the graphical user interface of the application comprises: outputting, by the computing device and for display, a request for confirmation to cease the output of the graphical user interface of the application; and responsive to receiving the confirmation to cease the output of the graphical user interface of the application, ceasing the output of the graphical user interface of the application at the computing device.

### Example 9

The method of any of examples 1-8, further comprising: responsive to detecting the second gesture, outputting, by the computing device for display, a trail substantially traversing the second gesture.

### Example 10

A computing device comprising: a display device; a presence-sensitive input device; and at least one processor configured to: output, for display on the display device, a graphical user interface of an application currently executing at the computing device; detect, using the presence-sensitive input device, a first gesture; determine whether the first gesture is initiated within a first target starting area of the presence-sensitive input device and terminates in a first target termination area of the presence-sensitive input device diagonal from the first target starting area; detect, using the presence-sensitive input device, a second gesture; determine whether the second gesture is initiated in a second target starting area of the presence-sensitive input device and terminates in a second target termination area of the presence-sensitive input device diagonal from the second target starting area, wherein the second target starting area is different from the first target starting and first target termination areas; determine whether an amount of time between termination of the first gesture and initiation of the second gesture satisfies a timeout threshold; and responsive to determining that the amount of time satisfies the timeout threshold, that the first gesture is initiated within the first target starting area and terminates in the first target termination area and that the second gesture is initiated within the second target starting area and terminates in the second target termination area, cease the output of the graphical user interface of the application at the computing device.

### Example 11

The computing device of example 10, wherein the at least one processor is further configured to: responsive to determining that one or more of the first gesture is initiated in an area proximate to the first target starting area but not in the first target starting area, the first gesture terminates in an area proximate to the first target termination area but not in the first target termination area, the second gesture is initiated in an area proximate to the second target starting area but not in the second target starting area, or the second gesture terminates in an area proximate to the second target termination area but not in the second target termination area: outputting, by the computing device and for display, a respective graphical element that substantially covers a respective portion of the graphical user interface that corresponds to each of the first target starting area, the first target termination area, the second target starting area, and the second target termination area.

### Example 12

The computing device of any of examples 10-11, wherein the graphical user interface of the application currently executing at the computing device is a first graphical user interface and wherein the application is a first application, wherein the at least one processor is further configured to: output, for display, a second graphical user interface different from the first graphical user interface, wherein the second graphical user interface is one of a graphical user interface of a second application currently executing on the computing device or a graphical user interface of an operating system executing at the computing device.

### Example 13

The computing device of any of examples 10-12, wherein the at least one processor being configured to cease the output of the graphical user interface of the application at the computing device comprises the at least one processor being configured to: output, for display, a request for confirmation to cease the output of the graphical user interface of the application; and responsive to receiving the confirmation to cease the output of the graphical user interface of the application, cease the output of the graphical user interface of the application at the computing device.

### Example 14

The computing device of any of examples 10-13, wherein the at least one processor is further configured to: responsive to detecting the second gesture, output, for display, a trail substantially traversing the second gesture.

### Example 15

The computing device of any of examples 10-14, wherein the at least one processor is further configured to: responsive to determining that the amount of time satisfies the timeout threshold, that the first gesture is initiated within the first target starting area and terminates in the first target termination area and that the second gesture is initiated within the second target starting area and terminates in the second target termination area, cease execution of the application at the computing device.

### Example 16

A computer-readable storage medium comprising instructions that, when executed, cause at least one processor of a computing device to: output, for display on the display device, a graphical user interface of an application currently executing at the computing device; detect, using a presence-sensitive input device, a first gesture; determine whether the first gesture is initiated within a first target starting area of the presence-sensitive input device and terminates in a first target termination area of the presence-sensitive input device diagonal from the first target starting area; detect, using the presence-sensitive input device, a second gesture; determine whether the second gesture is initiated in a second target starting area of the presence-sensitive input device and terminates in a second target termination area of the presence-sensitive input device diagonal from the second target starting area, wherein the second target starting area is different from the first target starting and first target termination areas; determine whether an amount of time between termination of the first gesture and initiation of the second gesture satisfies a timeout threshold; and responsive to determining that the amount of time satisfies the timeout threshold, that the first gesture is initiated within the first target starting area and terminates in the first target termination area and that the second gesture is initiated within the second target starting area and terminates in the second target termination area, cease the output of the graphical user interface of the application at the computing device.

### Example 17

The computer-readable storage medium of example 16, wherein the time threshold is a first time threshold, and wherein the instructions, when executed, further cause the at least one processor to: responsive to determining that one or more of the first gesture is initiated in an area proximate to the first target starting area but not in the first target starting area, the first gesture terminates in an area proximate to the first target termination area but not in the first target termination area, the second gesture is initiated in an area proximate to the second target starting area but not in the second target starting area, or the second gesture terminates in an area proximate to the second target termination area but not in the second target termination area: output, for display, a respective graphical element that substantially covers a respective portion of the graphical user interface that corresponds to each of the first target starting area, the first target termination area, the second target starting area, and the second target termination area.

### Example 18

The computer-readable storage medium of any of examples 16-17, wherein the graphical user interface of the application currently executing at the computing device is a first graphical user interface and wherein the application is a first application, wherein the instructions, when executed, further cause the at least one processor to: output, for display, a second graphical user interface different from the first graphical user interface, wherein the second graphical user interface is one of a graphical user interface of a second application currently executing on the computing device or a graphical user interface of an operating system executing at the computing device.

### Example 19

The computer-readable storage medium of any of examples 16-18, wherein the instructions that cause the at least one processor to cease the output of the graphical user interface of the application comprise instructions that, when executed, further cause the at least one processor to: output, for display, a request for confirmation to cease the output of the graphical user interface of the application; and responsive to receiving the confirmation to cease the output of the graphical user interface of the application, cease the output of the graphical user interface of the application at the computing device.

### Example 20

The computer-readable storage medium of any of examples 16-19, wherein the instructions, when executed, further cause the at least one processor to: responsive to detecting the second gesture, output, for display, a trail substantially traversing the second gesture.

### Example 21

A computing device configured to perform any of the methods of examples 1-10.

### Example 22

A computer-readable storage medium comprising instructions that, when executed, cause at least one processor of a computing device to perform any of the methods of examples 1-10.

By way of example, and not limitation, such computer-readable storage media can include RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transient media, but are instead directed to non-transient, tangible storage media. Disk and disc, as used, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor,” as used may refer to any of the foregoing structure or any other structure suitable for implementation of the techniques described. In addition, in some aspects, the functionality described may be provided within dedicated hardware and/or software modules. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a hardware unit or provided by a collection of interoperative hardware units, including one or more processors as described above, in conjunction with suitable software and/or firmware.

It is to be recognized that depending on the embodiment, certain acts or events of any of the methods described herein can be performed in a different sequence, may be added, merged, or left out altogether (e.g., not all described acts or events are necessary for the practice of the method). Moreover, in certain embodiments, acts or events may be performed concurrently, e.g., through multi-threaded processing, interrupt processing, or multiple processors, rather than sequentially.

In some examples, a computer-readable storage medium may include a non-transitory medium. The term “non-transitory” may indicate that the storage medium is not embodied in a carrier wave or a propagated signal. In certain examples, a non-transitory storage medium may store data that can, over time, change (e.g., in RAM or cache).

Various examples of the disclosure have been described. Any combination of the described systems, operations, or functions is contemplated. These and other examples are within the scope of the following claims.

1. A method comprising:
outputting, by a computing device and for display, a graphical user interface of an application currently executing at the computing device;
detecting, by a presence-sensitive input device operably coupled to the computing device, a first gesture;
determining, by the computing device, whether the first gesture is initiated within a first target starting area of the presence-sensitive input device and terminates in a first target termination area of the presence-sensitive input device diagonal from the first target starting area;
detecting, by the presence-sensitive input device, a second gesture;
determining, by the computing device, whether the second gesture is initiated in a second target starting area of the presence-sensitive input device and terminates in a second target termination area of the presence-sensitive input device diagonal from the second target starting area, wherein the second target starting area is different from the first target starting and first target termination areas;
determining, by the computing device, whether an amount of time between termination of the first gesture and initiation of the second gesture satisfies a timeout threshold; and
responsive to determining that the amount of time satisfies the timeout threshold, that the first gesture is initiated within the first target starting area and terminates in the first target termination area and that the second gesture is initiated within the second target starting area and terminates in the second target termination area, ceasing the output of the graphical user interface of the application at the computing device.

2. The method of claim 1, the method further comprising:
responsive to determining that one or more of the first gesture is initiated in an area proximate to the first target starting area but not within the first target starting area, the first gesture terminates in an area proximate to the first target termination area but not within the first target termination area, the second gesture is initiated in an area proximate to the second target starting area but not within the second target starting area, or the second gesture terminates within an area proximate to the second target termination area but not in the second target termination area:
outputting, by the computing device and for display, a respective graphical element that substantially covers a respective portion of the graphical user interface that corresponds to each of the first target starting area, the first target termination area, the second target starting area, and the second target termination area.

3. The method of claim 1, wherein the graphical user interface of the application currently executing at the computing device is a first graphical user interface and wherein the application is a first application, the method further comprising:
outputting, by the computing device and for display, a second graphical user interface different from the first graphical user interface.

4. The method of claim 1, wherein the graphical user interface encompasses the entire display.

5. The method of claim 1, further comprising, responsive to determining that the amount of time satisfies the timeout threshold, that the first gesture is initiated within the first target starting area and terminates in the first target termination area and that the second gesture is initiated within the second target starting area and terminates in the second target termination area, ceasing execution of the application at the computing device.

6. The method of claim 1, wherein the first target starting area is an area on the presence-sensitive input device that corresponds to an upper-left corner of the graphical user interface, wherein the first target termination area is an area on the presence-sensitive input device that corresponds to a lower-right corner of the graphical user interface, wherein the second target starting area is an area on the presence-sensitive input device that corresponds to an upper-right corner of the graphical user interface, and wherein the second target termination area is an area on the presence-sensitive input device that corresponds to a lower-left corner of the graphical user interface.

7. The method of claim 1, wherein the first gesture and the second gesture each span a distance greater than or equal to 75% of the length of a diagonal measurement of the presence-sensitive input device.

8. The method of claim 1, wherein ceasing the output of the graphical user interface comprises:
outputting, by the computing device and for display, a request for confirmation to cease the output of the graphical user interface; and
responsive to receiving the confirmation to cease the output of the graphical user interface, ceasing the output of the graphical user interface at the computing device.

9. The method of claim 1, further comprising:
responsive to detecting the second gesture, outputting, by the computing device for display, a trail substantially traversing the second gesture.

10. A computing device comprising:
a display device;
a presence-sensitive input device; and
at least one processor configured to:
output, for display on the display device, a graphical user interface of an application currently executing at the computing device;
detect, using the presence-sensitive input device, a first gesture;
determine whether the first gesture is initiated within a first target starting area of the presence-sensitive input device and terminates in a first target termination area of the presence-sensitive input device diagonal from the first target starting area;
detect, using the presence-sensitive input device, a second gesture;
determine whether the second gesture is initiated in a second target starting area of the presence-sensitive input device and terminates in a second target termination area of the presence-sensitive input device diagonal from the second target starting area, wherein the second target starting area is different from the first target starting and first target termination areas;
determine whether an amount of time between termination of the first gesture and initiation of the second gesture satisfies a timeout threshold; and
responsive to determining that the amount of time satisfies the timeout threshold, that the first gesture is initiated within the first target starting area and terminates in the first target termination area and that the second gesture is initiated within the second target starting area and terminates in the second target termination area, cease the output of the graphical user interface of the application at the computing device.

11. The computing device of claim 10, wherein the at least one processor is further configured to:
responsive to determining that one or more of the first gesture is initiated in an area proximate to the first target starting area but not in the first target starting area, the first gesture terminates in an area proximate to the first target termination area but not in the first target termination area, the second gesture is initiated in an area proximate to the second target starting area but not in the second target starting area, or the second gesture terminates in an area proximate to the second target termination area but not in the second target termination area:
outputting, by the computing device and for display, a respective graphical element that substantially covers a respective portion of the graphical user interface that corresponds to each of the first target starting area, the first target termination area, the second target starting area, and the second target termination area.

12. The computing device of claim 10, wherein the graphical user interface of the application currently executing at the computing device is a first graphical user interface and wherein the application is a first application, wherein the at least one processor is further configured to:
output, for display, a second graphical user interface different from the first graphical user interface, wherein the second graphical user interface is one of a graphical user interface of a second application currently executing on the computing device or a graphical user interface of an operating system executing at the computing device.

13. The computing device of claim 10, wherein the at least one processor being configured to cease output of the graphical user interface of the application at the computing device comprises the at least one processor being configured to:
output, for display, a request for confirmation to cease output of the graphical user interface; and
responsive to receiving the confirmation to cease output of the graphical user interface of the application, cease output of the graphical user interface of the application at the computing device.

14. The computing device of claim 10, wherein the at least one processor is further configured to:
responsive to detecting the second gesture, output, for display, a trail substantially traversing the second gesture.

15. The computing device of claim 10, wherein the at least one processor is further configured to:
responsive to determining that the amount of time satisfies the timeout threshold, that the first gesture is initiated within the first target starting area and terminates in the first target termination area and that the second gesture is initiated within the second target starting area and terminates in the second target termination area, cease execution of the application at the computing device.

16. A computer-readable storage medium comprising instructions that, when executed, cause at least one processor of a computing device to:
output, for display on the display device, a graphical user interface of an application currently executing at the computing device;
detect, using a presence-sensitive input device, a first gesture;
determine whether the first gesture is initiated within a first target starting area of the presence-sensitive input device and terminates in a first target termination area of the presence-sensitive input device diagonal from the first target starting area;
detect, using the presence-sensitive input device, a second gesture;
determine whether the second gesture is initiated in a second target starting area of the presence-sensitive input device and terminates in a second target termination area of the presence-sensitive input device diagonal from the second target starting area, wherein the second target starting area is different from the first target starting and first target termination areas;
determine whether an amount of time between termination of the first gesture and initiation of the second gesture satisfies a timeout threshold; and
responsive to determining that the amount of time satisfies the timeout threshold, that the first gesture is initiated within the first target starting area and terminates in the first target termination area and that the second gesture is initiated within the second target starting area and terminates in the second target termination area, cease the output of the graphical user interface of the application at the computing device.

17. The computer-readable storage medium of claim 16, wherein the time threshold is a first time threshold, and wherein the instructions, when executed, further cause the at least one processor to:
responsive to determining that one or more of the first gesture is initiated in an area proximate to the first target starting area but not in the first target starting area, the first gesture terminates in an area proximate to the first target termination area but not in the first target termination area, the second gesture is initiated in an area proximate to the second target starting area but not in the second target starting area, or the second gesture terminates in an area proximate to the second target termination area but not in the second target termination area:
output, for display, a respective graphical element that substantially covers a respective portion of the graphical user interface that corresponds to each of the first target starting area, the first target termination area, the second target starting area, and the second target termination area.

18. The computer-readable storage medium of claim 16, wherein the graphical user interface of the application currently executing at the computing device is a first graphical user interface and wherein the application is a first application, wherein the instructions, when executed, further cause the at least one processor to:
output, for display, a second graphical user interface different from the first graphical user interface, wherein the second graphical user interface is one of a graphical user interface of a second application currently executing on the computing device or a graphical user interface of an operating system executing at the computing device.

19. The computer-readable storage medium of claim 16, wherein the instructions that cause the at least one processor to cease the output of the graphical user interface comprise instructions that, when executed, further cause the at least one processor to:
output, for display, a request for confirmation to cease the output of the graphical user interface; and
responsive to receiving the confirmation to cease the output of the graphical user interface, cease the output of the graphical user interface at the computing device.

20. The computer-readable storage medium of claim 16, wherein the instructions, when executed, further cause the at least one processor to:
responsive to detecting the second gesture, output, for display, a trail substantially traversing the second gesture.
